(19) United States
(12) Patent Application Publication
(10) Pub. No.: US 2014/0063389 A1
(43) Pub. Date: Mar. 6, 2014

(54) DISPLAY DEVICE

(71) Applicant: Toshihisa Matsumoto, Yokkaichi (JP)

(72) Inventor: Toshihisa Matsumoto, Yokkaichi (JP)

(73) Assignee: SUMITOMO WIRING SYSTEMS, LTD., Yokkaichi, Mie (JP)

(21) Appl. No.: 14/114,828

(22) PCT Filed: Nov. 9, 2011
(86) PCT No.: PCT/JP2011/006278

§ 371 Date: Oct. 30, 2013

(30) Foreign Application Priority Data
May 25, 2011 (JP) 2011-117202

(51) Int. Cl. G02F 1/133

(52) U.S. Cl. CPC G02F 1/13306
USPC 349/33

(57) ABSTRACT

A display device including a display panel, further including one or more segment electrodes, a plurality of common electrodes, and pixels which are positioned at the intersections of these electrodes, and carrying out a display wherein drive voltages are applied to the pixels; first and second segment drivers, which drive the segment electrodes; and first and second common drivers which drive the common electrodes. The common electrodes are divided into at least first and second groups. Each common driver and each segment driver is respectively disposed corresponding to the first and second groups. The drive period of the first common driver and the drive period of the second common driver overlap at least partially.

This application is the national phase of PCT International Application No. PCT/JP2011/006278 that has an International filing date of Nov. 9, 2011 and designated the United States of America and claims priority to Japanese Patent App. No. JP 2011-117202 that was filed on May 25, 2011.

### BACKGROUND

Some embodiments relate to a display device that is implemented by a liquid crystal display device or the like.

In related art such as a frequency display, a music title display, or similar embodiments using a radio, a simple display device is used that displays thing such as numbers and letters. FIG. 2 is a front view showing an example of this type of display device 1. A display panel 2 of this display device 1 can display 13 digits (characters). In FIG. 2, one digit (character) from among 13 digits (characters) is framed and is shown as reference symbol S1. In this display panel 2, pixels (segments) 3 of five by seven dots in a matrix are used for a one-digit (character) display.

FIG. 3 is a schematic wiring diagram of a display device 10 in which a drive circuit is provided with a display panel 20 similar to the display panel 2 shown in FIG. 2. For the 13-digit (character) display, the display panel 20 is formed in a longitudinal shape provided with long and short sides. The drive circuit includes a segment driver 40 arranged along the long side and a common driver 50 arranged along the short side. The display panel 20 performs the 13-digit (character) display and uses pixels (segments) 3 of five by seven dots in a matrix for one-digit (character); thus, it has 65 segment electrodes SEG 1-SEG 65 and seven common electrodes COM 1-COM 7. The segment driver 40 controls the respective segment electrodes SEG 1-SEG 65 from terminals T1-T65, and the common driver 50 controls the respective common electrodes COM 1-COM 7 from terminals P1-P7.

Thus, the display panel 20 is not a static drive type display panel in which each pixel is individually driven. Rather, it is a dynamic drive type display panel that is provided with the segment electrodes SEG 1-SEG 65 and the common electrodes COM 1-COM 7. It can drive many pixels with a relatively small number of terminals by applying a drive voltage to the pixels at the intersections of these electrodes and performing a display by making the pixels either bright or faint. Additionally, within the category of dynamic drive type display panels, the display panel 20 is a simple display device showing things like numbers and letters, instead of an image or something similar, and is a simple (passive) matrix type liquid crystal display panel that does not have a charge-storing element and a control switch element in each pixel 3.

Japanese Published Patent Application 64-78296 discloses a general drive method of a liquid crystal panel in a simple matrix type liquid crystal display panel. The drive method is a reversing drive method that suppresses deterioration of a liquid crystal panel by reversing a drive signal of a drive circuit at a predetermined cycle.

The above-mentioned dynamic drive type display device uses the segment electrodes SEG 1-SEG 65 and the common electrodes COM 1-COM 7, which are common to a plurality of pixels 3, but each pixel 3 (segment) performs an individual display. In the above-mentioned example of five by seven dots, the seven common electrodes COM 1-COM 7 are selected in order, and each pixel 3 (segment) is driven at a 1/7 duty. Thus, in each pixel during a non-selection period, an applied voltage decreases as time elapses. Meanwhile, in a static drive type display panel in which an individual terminal is arranged at each pixel and each pixel is individually driven, each pixel is constantly driven, and the voltage does not decrease.

In a dynamic drive type display device, many pixels can be driven by a relatively small number of terminals, but a period in which the voltage is applied to each pixel 3 (segment) becomes shortened. There is a tendency that, because of the above-mentioned voltage decrease, a display contrast (brightness ratio of ON and OFF segments) and an angle of visibility become poor. Appearance (display quality) also becomes poor. Furthermore, the higher the driving duty and the fewer the number of terminals, the more such a tendency can be seen.

### SUMMARY

Some embodiments therefore provide a display device that can enhance display quality of a display device using a dynamic drive type display panel.

A display device related to an embodiment of this invention is provided with one or a plurality of segment electrodes, a plurality of common electrodes, pixels arranged at intersections of these electrodes, a display panel in which a drive voltage is applied to the pixels and display is performed, first and second segment drivers that drive the segment electrodes, and first and second common drivers that drive the common electrodes. The common electrodes are divided into at least first and second groups. The respective common drivers and segment drivers are arranged corresponding to the first and second groups, respectively, and a driving period of the first common driver and a driving period of the second common driver at least partially overlap each other.

### BRIEF DESCRIPTION OF THE DRAWINGS

FIG. 1 is a schematic wiring diagram of a display device related to an embodiment of this invention.

FIG. 2 is a front view of an embodiment of a simple display device showing things such as numbers and letters.

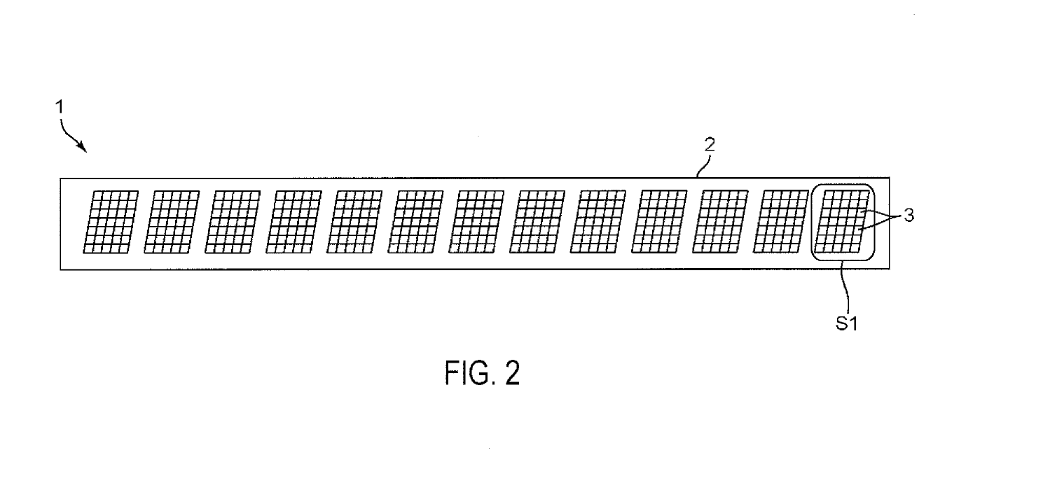

FIG. 3 is a schematic wiring diagram of a display device provided with a drive circuit.

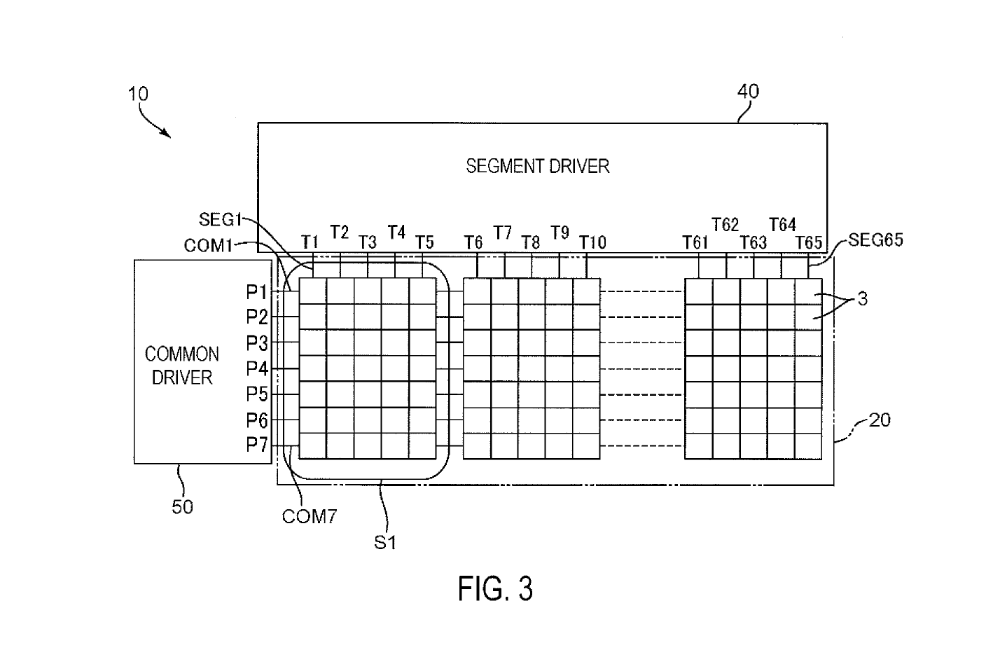

### DETAILED DESCRIPTION OF THE EMBODIMENTS

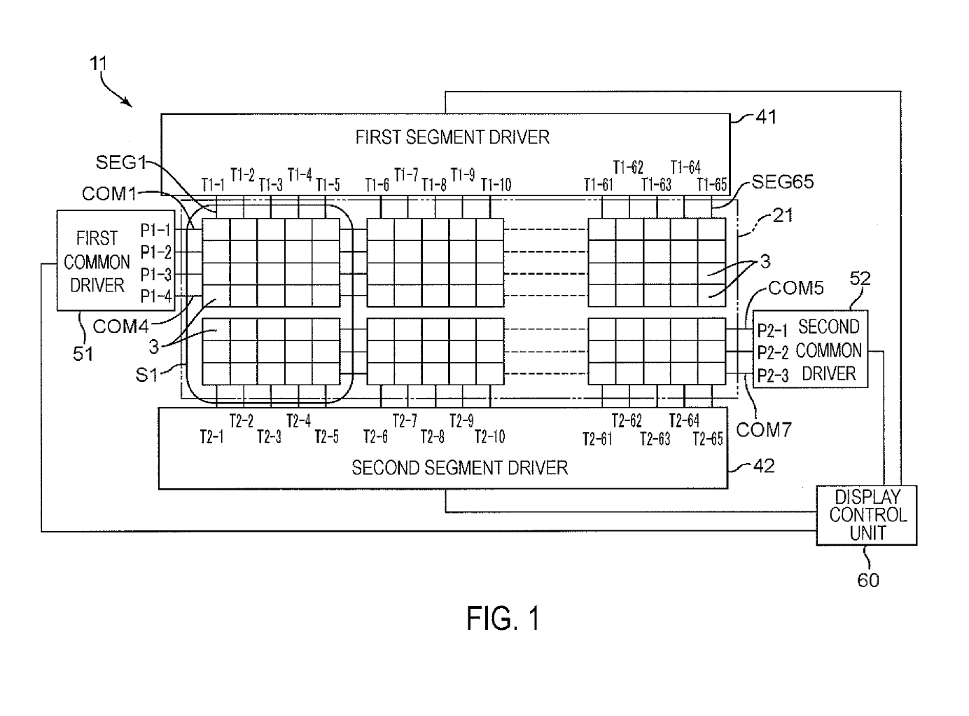

FIG. 1 is a schematic wiring diagram of a display device 11 related to an embodiment of this invention. A display device 11 includes a display panel 21 and its drive circuit. The drive circuit is provided with (i) a driver group constituted by a first segment driver 41, a second segment driver 42, a first common driver 51, and a second common driver 52 and (ii) a display control circuit 60 that controls these driver groups. The display panel 20 is formed in a longitudinal shape provided with long and short sides. The first segment driver 41 is arranged along one long side of the display panel 20, and the second segment driver 42 is arranged along the other long side. Furthermore, the first common driver 51 is arranged along one short side of the display panel 20, and the second common driver 42 is arranged along the other short side.

The display panel 21 can display 13 digits (characters). In FIG. 1, the framed portion shown by reference symbol S1 is one segment for displaying one digit (character). Thus, the display panel 21 has 13 segments. To display one digit (character), pixels (segments) 3 of five by seven dots in a matrix are used. Thus, similar to display panel 20, this display panel 21 has 65 segment electrodes SEG 1-SEG 65 and seven common electrodes COM 1-COM 7.

The pixels 3 are arranged at the respective intersections of the segment electrodes SEG 1-SEG 65 and the common electrodes COM 1-COM 7. The display panel 21 is a dynamic drive type display panel that can drive many pixels 3 with a relatively small number of terminals by applying a drive voltage to the pixels 3 arranged at the intersections. The display panel 21 performs a display by making the pixels either bright or faint. Additionally, within the category of dynamic drive type display panels, the display panel 21 is a simple display device showing things such as numbers and letters, instead of things like images. Thus, the display panel 21 is a simple (passive) matrix type liquid crystal display panel that does not have a charge-storing element and a control switch element in each pixel 3.

The seven common electrodes COM 1-COM 7 are divided into two groups, one of the four common electrodes COM 1-COM 4 and one of the three common electrodes COM 5-COM 7. The former group is driven by the first common driver 51, and the latter group is driven by the second common driver 52. Specifically, the common electrodes COM 1-COM 4 are alternatively driven by terminals P1-1-P1-4 of the first common driver 51, and the common electrodes COM 5-COM 7 are alternatively driven by terminals P2-1-P2-3 of the second common driver 52.

The 65 segment electrodes SEG 1-SEG 65 are divided into two portions, an upper portion and a lower portion, using a space between the common electrodes COM 4 and COM 5 as a boundary. The upper portion of the segment electrodes SEG 1-SEG 65 is driven by the first segment driver 41, and the lower portion of the segment electrodes SEG 1-SEG 65 is driven by the second segment driver 42. Specifically, the side of the common electrodes COM 1-COM 4 and of the segment electrodes SEG 1-SEG 65 is all together simultaneously driven by terminals T1-1-T1-65 of the first segment driver 41, and the side of the common electrodes COM 5-COM 7 and of the segment electrodes SEG 1-SEG 65 is all together simultaneously driven by terminals T2-1-T2-65 of the second segment driver 42.

The first and second common drivers 51, 52 perform driving at a 1/4 duty of a unit drive cycle T. The common electrodes COM 1-COM 3 and the common electrodes COM 5-COM 7 are shifted by a period of T/4 from a start time of the unit drive cycle T and are driven in order. Meanwhile, only the common electrode COM 4 is driven alone during the last period T/4 of the unit drive cycle T. That is, first, the common electrodes COM 1, COM 5 are driven at the start time of the cycle T. The common electrodes COM 2, COM 6 are driven after a period T/4 elapses from the start time. The common electrodes COM 3, COM 7 are driven after a further T/4 period elapses. And the common electrode COM 4 is driven after a further T/4 period elapses.

The display control circuit 60 generates a control signal corresponding to an image displayed on the display panel 21, and the control signal is given to the first and second segment drivers 41, 42 and the first and second common drivers 51, 52. Specifically, the control signal includes (i) a timing control signal for the above-mentioned simultaneous driving by the first and second segment drivers 41, 42, and (ii) a timing control signal for driving at the above-mentioned 1/4 duty by the first and second common drivers 51, 52.

The first and second common drivers 51, 52 divide and drive the plurality of common electrodes COM 1-COM 7, and the duty can increase because at least part of the common electrodes (the common electrodes COM 1-COM 3 and the common electrodes COM 5-COM 7 of this embodiment) can be simultaneously (in parallel) driven. Thus, the period in which a voltage is applied to each pixel 3 can be made long. Thus the contrast (brightness ratio of ON segments and OFF segments) can be improved. Additionally, an angle of visibility of the display panel 21 becomes wide, and it is possible to improve the appearance or display quality. For example, by the display panel 21 of this embodiment, high display quality comparable to that of an LCD that displays a small amount of information formed by “symbol segments” can be realized while having an information amount of “segments of five by seven dots.”

In the above-mentioned case of “segments of five by seven dots,” seven common electrodes are needed. Thus, according to some technology, the common electrodes would be driven at a 1/7 duty. However, if the seven common electrodes COM 1-COM 7 are divided into two groups, one of four electrodes and one of three electrodes, they can be driven at a 1/4 duty by performing the above-mentioned simultaneous driving. Thus, the charging period for the pixels 3 can be extended from the 1/7 period of the unit drive cycle T to the 1/4 period. The charging period can be made 75% longer. In the case in which the display panel 21 is a simple (passive) matrix liquid crystal display panel, like in this embodiment, an applied voltage of each pixel 3 decreases as time elapses. Thus, making the charging period longer is especially effective in order to improve the display quality of the display panel 21.

Additionally, if the common electrodes COM 1-COM 7 are divided into two groups, the segment drivers can also be divided in two. Thus, the segment drivers can be divided into the first driver 41 and the second driver 42, and these drivers can be arranged at two opposing sides (long sides in the above-mentioned example) of the display panel 21, respectively. The first and second common drivers 51, 52 are arranged at the opposing short sides of the longitudinal display panel 21, but they can also be arranged at the same short side.

The respective common electrodes COM 1-COM 7 can be driven at an equal 1/4 duty. In the group of the three common electrodes COM 5-COM 7, the charging period can also be made even longer by driving at a 1/3 duty. However, in view of eliminating brightness irregularities of the display panel 21, it is preferable to make the duty uniform for all the common electrodes COM 1-COM 7. It is desirable to make the duty match the smaller duty (1/4 duty) from among the two groups as described in the embodiment, and for the common electrodes COM 5-COM 7, in which the duty could have been increased, to make a one-common-electrode portion of a driving period of blank, and make all the common electrodes COM 1-COM 7 to be driven at an equal duty.

Additionally, an example is shown in which the seven common electrodes COM 1-COM 7 are divided into two groups, one of the four common electrodes COM 1-COM 4 and one of the three common electrodes COM 5-COM 7. However, the common electrodes may also be divided into three or more groups of common electrodes, such as groups of three, two, and two common electrodes. However, if they are divided into three or more groups of electrodes, a plurality of segment drivers would need to be arranged on at least one long side on the display panel 21 that has a longitudinal shape. At the pixels positioned on the short side direction or end portion side (pixels of the row of the terminal P1-1 or the terminal P2-3), a plurality of segment electrodes would be formed at one pixel. In a simple (passive) matrix liquid crystal display panel, there is a possibility of generating cross talk. Because of this, the preferable number of divided groups is two.

Furthermore, in the above-mentioned embodiment, an example is shown in which the seven common electrodes COM 1-COM 7 are provided. But a different number of common electrodes than seven common electrodes may be used. For example, assuming that the display panel 21 has a plurality of segments that become display units and a drive voltage is applied by m segment electrodes and n common electrodes, it is desirable that the n common electrodes are divided into (i) a first group that is driven by the first common driver 51 and constituted by n/2 common electrodes, and (ii) a second group that is driven by the second common driver 52 and constituted by n/2 or (n/2−1) common electrodes. If the common electrodes are thus divided into groups, the burden of the first and second common drivers 51, 52 may be substantially made equal, so a control balance can be made.

In this case, it is desirable that the display control circuit 60 makes (i) the timing at which the first common driver 51 starts driving with respect to the first group of common electrodes and (ii) the timing at which the second common driver 52 starts driving with respect to the second group of common electrodes identical to each other. By so doing, the driving times of the respective common drivers 51, 52 can have maximum overlap with each other, and the charging period for the pixels 3 can be made as long as possible.

A display device is provided with one or a plurality of segment electrodes, a plurality of common electrodes, pixels arranged at intersections of these electrodes, a display panel in which a drive voltage is applied to the pixels and display is performed, first and second segment drivers that drive the segment electrodes, and first and second common drivers that drive the common electrodes. The common electrodes are divided into at least first and second groups, the respective common drivers and segment drivers are arranged corresponding to the first and second groups, respectively, and a driving period of the first common driver and a driving period of the second common driver at least partially overlap each other.

According to the above-mentioned structure, in a display device using a dynamic drive type display panel, a drive method can be improved. Because the segment drivers make a selection, one or a plurality of signal lines, or row selection lines, are all together (simultaneously) driven. Because the common drivers make a selection, arbitrary common lines, or row selection lines, are alternatively driven. Here, there are first and second groups that are formed by collecting one or a plurality of the common electrodes, and first and second common drivers and first and second segments are arranged accordingly. Additionally, in the driving periods of the first and second common drivers, both periods at least partially overlap with each other. Because the first and second common drivers divide and drive the plurality of common electrodes, at least part of the common electrodes can be simultaneously (in parallel) driven.

Thus, in a unit drive cycle T, if the number of common electrodes driven by the common driver of a group having a maximum number of common electrodes is N, each common electrode can be driven in a period TIN, or a 1/N duty, in that group. Thus, by increasing the duty, the period in which voltage is applied to each pixel increases, and the contrast (brightness ratio of ON segments and OFF segments) can be improved. At the same time, the angle of visibility becomes wide, and it is possible to increase the appearance or display quality.

It is desirable that the display panel is a simple matrix liquid crystal display panel.

In the case of a simple (passive) matrix liquid crystal display panel, the applied voltage of each pixel decreases as time elapses. Because of this, this display is especially effective.

It is desirable that the common electrodes are only divided into the first and second groups. According to this structure, only two segment drivers are needed, and a plurality of segment electrodes do not have to be arranged at one pixel.

It is desirable that the display panel has a plurality of segments that become display units. One of the segments is constituted by pixels of five by seven dots, and the common electrodes are divided into (i) a first group formed by four common electrodes, and (ii) a second group formed by three common electrodes.

In the case of “segments of five by seven dots”, seven common electrodes are needed. Normally the common electrodes are driven at a 1/7 duty. However, the seven common electrodes are divided into two groups. The first common driver drives four electrodes, and the second common driver drives three electrodes. So they can be driven at a 1/4 duty. Thus, the charging period for the pixels can be increased from the 1/7 period of the unit drive cycle T to the 1/4 period. The charging period can be made 75% longer. Additionally, only two segment drivers are needed and can be arranged respectively at opposite sides of the display panel.

The first and second common drivers drive each common electrode at an equal 1/4 duty. Driving of the first group of the common electrodes and the second group of the common electrodes starts at the same time. For the second group of the common electrodes, a one-common-electrode portion of the driving period is made blank. Additionally, it is desirable that the respective common electrodes are driven at an equal 1/4 duty, and in the group of three common electrodes, a one-common-electrode portion of the driving period is made blank.

According to the above-mentioned structure, instead of driving the group of three common electrodes at a 1/3 duty and the group of four common electrodes at a 1/4 duty, both groups are driven at the same 1/4 duty. Thus, the duty is equal to each other, and brightness irregularities can be eliminated.

1. A display device, comprising:
a display panel including one or a plurality of segment electrodes, a plurality of common electrodes, and pixels arranged at intersections of the electrodes, in which a drive voltage is applied to the pixels and a display is performed;
first and second segment drivers that drive the segment electrodes; and
first and second common drivers that drive the common electrodes,
wherein the common electrodes are divided into at least first and second groups,
the common drivers and the segment drivers are respectively arranged corresponding to the first and second groups, and
a driving period of the first common driver and a driving period of the second common driver are at least partially overlapped with each other.

2. The display device as set forth in claim 1,
wherein the display panel is a simple matrix liquid crystal display panel.

3. The display device as set forth in claim 2,
wherein the common electrodes are divided into the first and second groups only.

4. The display device as set forth in claim 2,
wherein the display panel has a plurality of segments that become display units, and one of the segments is constituted by pixels of 5×7 dots, and
the common electrodes are divided into (i) a first group formed by four common electrodes, and (ii) a second group formed by three common electrodes.

5. The display device as set forth in claim 4,
wherein the first and second common drivers drive the respective common electrodes at an equal 1/4 duty,
driving of the first group of the common electrodes and the second group of the common electrodes starts at the same timing, and
for the second group of the common electrodes, a one-common-electrode portion of the driving period is made blank.

6. The display device as set forth in claim 2,
wherein the display panel has a plurality of segments that become display units,
a drive voltage is applied to one of the segments by m segment electrodes and n common electrodes, and
the n common electrodes are divided into (i) a first group driven by the first common driver and constituted by n/2 common electrodes and (ii) a second group driven by the second common driver and constituted by n/2 or (n/2−1) common electrodes.

7. The display device as set forth in claim 6,
wherein a timing at which the first common driver starts driving with respect to the first group of the common electrodes and a timing at which the second common driver starts driving with respect to the second group of the common electrodes are substantially identical to each other.
